(19) United States
(12) Patent Application Publication
(10) Pub. No.: US 2011/0121546 A1
(43) Pub. Date: May 26, 2011

(54) COMFORT PUSH STROLLER SYSTEM

(76) Inventor: Karen Stewart, Warren, MI (US)

(21) Appl. No.: 12/951,021

(22) Filed: Nov. 20, 2010

Related U.S. Application Data
(60) Provisional application No. 61/262,943, filed on Nov. 20, 2009.

(51) Int. Cl. B62B 3/02

(52) U.S. Cl. 280/650

(57) ABSTRACT

Comfort push stroller is a device with at least one adjustable handle that may be raised and lowered and/or telescoped, adjustable to accommodate user-pushers of varying heights. The handle(s) on this device may be adjustable thereby allowing the user to raise the handle(s) to a height that is found most comfortable by individuals of virtually all heights. The handle(s) may include at least one inner tube and at least one slightly larger outer tube that fits concentrically over the inner tube. Depressible spring-loaded push-buttons are located on the outer tubing and are designed to couple the inner tube to the outer tube in a locked relationship thereby permitting a user to vertically height-adjust and set the vertically adjustable handle to a user-preferred height via telescoping action.

### CROSS-REFERENCE TO RELATED APPLICATION

The present application is related to and claims priority from prior provisional application Ser. No. 61/262,943, filed Nov. 20, 2009 which application is incorporated herein by reference.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever. 37 CFR 1.71(d).

### BACKGROUND OF THE INVENTION

1. Field of the Invention

The present invention relates generally to the field of strollers and more specifically relates to strollers with an adjustable handle that may be height-manipulated to provide a comfortable position for the user-pusher.

2. Description of the Related Art

The following includes information that may be useful in understanding the present invention(s). It is not an admission that any of the information provided herein is prior art, or material, to the presently described or claimed inventions, or that any publication or document that is specifically or implicitly referenced is prior art.

Babies may be transported between locations using child carriers, strollers, or other such devices. A “child carrier” or “baby carrier” is a device typically used to carry an infant or small child on the body of an adult. Such on-the-body carriers are designed in various forms such as baby slings, backpack carriers, and soft front or hip carriers, with varying materials and degrees of rigidity, decoration, support and safe confinement of the child.

A stroller normally has the child strapped in a sitting position, usually facing forwards, instead of facing the pusher. Many parents and childcare workers enjoy pushing their infant in a stroller as they take a walk or go for a jog as the vast majority of the weight of the child is carried by the wheeled system. Unfortunately, strollers are traditionally designed and manufactured under the premise that one-size-fits-all. This quality leaves user-pushers that are taller than average no choice but to stoop over to reach the handles. Shorter user-pushers may be uncomfortably positioned as well. Remaining in a stooped position for continuous periods of time can result in serious back-related issues along with poor posture that may easily be avoided simply by using a properly fitted or adjusted stroller. Therefore a need exists for a stroller with a height adjustable handle that may be raised and lowered and/or telescoped to accommodate a wider height range of users.

Various attempts have been made to solve the above-mentioned problems such as those found in U.S. Pat. Nos. 5,845,917, 4,587,864, 5,625,923, 5,184,835, 7,032,911, and 7,011,335. This prior art is representative of strollers with adjustable handles. None of the above inventions and patents, taken either singly or in combination, is seen to describe the invention as claimed.

Ideally, a stroller should be user-friendly, and comfortable in-use. Additionally, the stroller must operate reliably and be manufactured at a modest expense. Thus, a need exists for a reliable comfort push stroller system with vertically adjustable handles to avoid the above-mentioned problems.

### BRIEF SUMMARY OF THE INVENTION

In view of the foregoing disadvantages inherent in the known stroller art, the present invention provides a novel comfort push stroller system. The general purpose of the present invention, which will be described subsequently in greater detail is to provide a stroller with adjustable handle(s) that may be raised and lowered and/or telescoped by the user to provide a comfortable position in which to push the child in. This device will allow taller and shorter than average mothers and fathers to push a stroller without causing back stress or poor body posture. Parents of ranging heights can adjust the handles with a push of button to find a position that is most comfortable for them as they walk or jog with their infant nestled inside the stroller seat.

The present comfort push stroller described herein preferably comprises: at least one vertically adjustable handle; with at least one inner tube; at least one outer tube; and at least one push-button located on the outer tubing. The vertically adjustable handle comprises metal in preferred embodiments and at least one cushioner. The inner tube and the outer tube are adjacently and concentrically located in relation to each other, the inner tube located within the confines of the outer tube so they may be telescoped when adjusted.

The inner tube preferably comprises a plurality of through-holes (apertures) located on mating side-arc portion(s) relative to the push-button. In this way the inner-tube is vertically adjustable downwardly and/or upwardly, and then locked in a desired position via the push-button. The locking relationship is accomplished via a friction relationship at the desired height, the available choices according to spaced-increments of the plurality of through-holes.

The quarter-sized push-button(s) may comprise a tensioned spring and by their relative sizing act to prevent accidental finger pinching as a user engages (compresses and/or tensions) the push-button. The spring of the push-button mechanism is in compression when the push-button is compressed. Conversely, the spring is in tension when the inner-tube is in a friction-locked position in one of the through-holes. The user-preferred height of the vertically adjustable handle is achieved when the push-button is tensioned thereby locking the vertically adjustable handle in a desired location. The push-button is designed to couple the inner tube to the outer tube in a locked relationship (preventing sliding telescopically in relation to each other) thereby providing a rigid member sufficient to push the stroller.

A kit is embodied herein for the comfort push stroller system comprising: the stroller with the vertically adjustable handle; push-buttons; at least one (optionally removably replaceable) cushioner (user-preferred coloring/design); and a set of user instructions.

In accordance with the embodiments of the present invention a preferred method of use is disclosed herein comprising: compressing at least one push-button; vertically adjusting an inner-tube relative to an outer-tube on the vertically adjustable handle according to the height of a user-pusher; and tensioning the push-button once a desired height is reached thereby locking the inner-tube to the outer-tube such that the comfort push stroller is at a user-preferred height—one that is comfortable in-use while pushing the stroller.

The present invention holds significant improvements and serves as a comfort push stroller system. For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and method(s) of use for the present invention, comfort push stroller system, constructed and operative according to the teachings of the present invention.

FIG. 1A is a perspective view illustrating a traditional push stroller in an ‘in-use’ condition.

FIG. 1B is a perspective view illustrating a comfort push stroller system in an ‘in-use’ condition as properly height-adjusted according to an embodiment of the present invention.

FIG. 2 is a perspective view illustrating an ‘in-use’ condition of the comfort push stroller system as used by a taller user-pusher according to an embodiment of the present invention of FIG. 1B.

FIG. 3 is a perspective view illustrating the user compressing push-buttons to adjust relative handle height according to an embodiment of the present invention of FIG. 1B.

FIG. 4 is a perspective view illustrating the user-pusher adjusting the vertically-adjustable handle(s) according to an alternate embodiment of the present invention of FIG. 1B.

FIG. 5. is a flowchart illustrating a method of use according to an embodiment of the present invention of FIGS. 1B-4.

The various embodiments of the present invention will hereinafter be described in conjunction with the appended drawings, wherein like designations denote like elements.

### DETAILED DESCRIPTION

As discussed above, embodiments of the present invention relate to a stroller device and more particularly to a comfort push stroller system 100 as used to permit user-pushers of various heights to comfortably push a stroller.

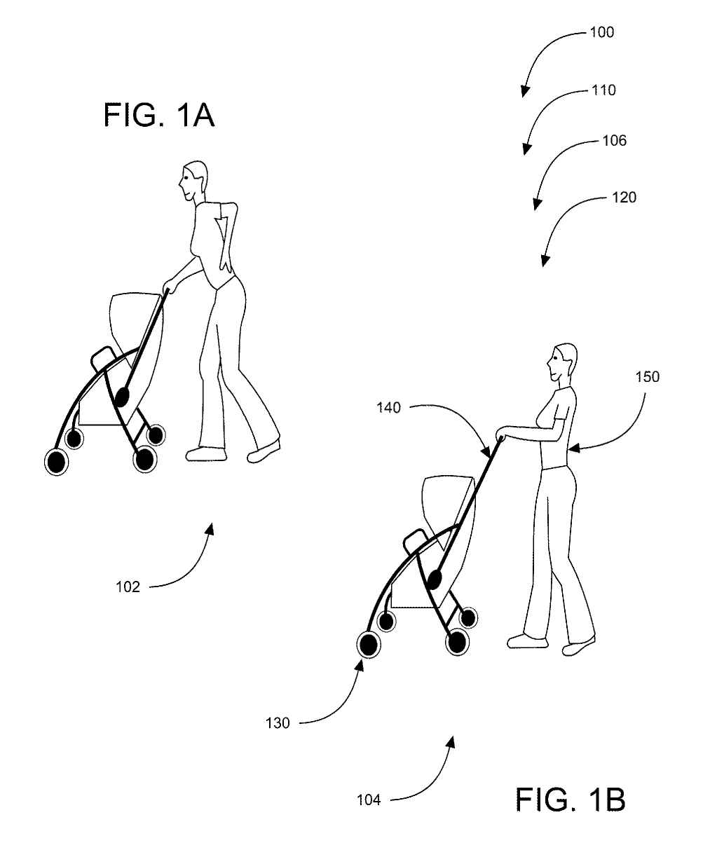

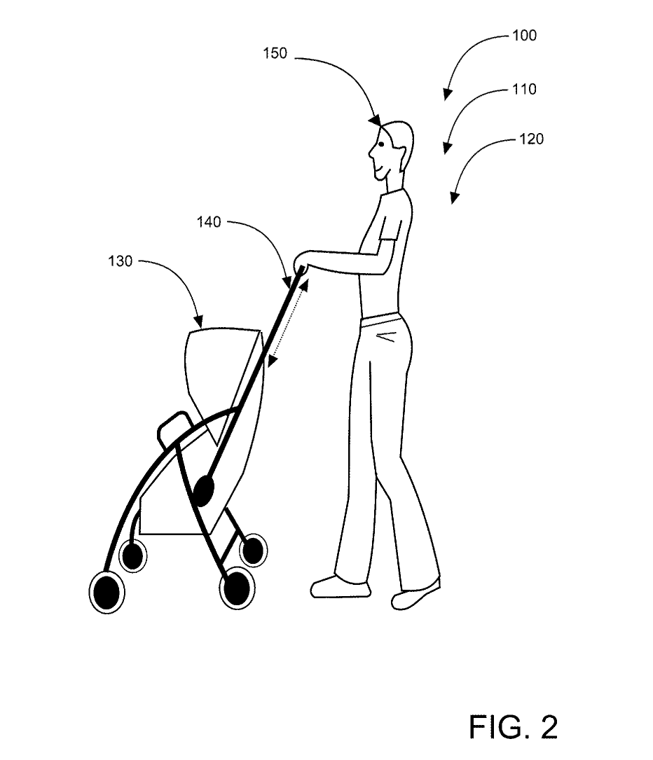

Referring to the drawings by numerals of reference there is shown in FIGS. 1A-2, perspective views illustrating comfort push stroller system 100 in ‘in-use’ condition(s) 120. FIG. 1 specifically alludes to comfort push stroller system 100 (alternately named just my height stroller 110) as improperly height-adjusted in the left side image (generally referenced as 102) and properly height adjusted in the right side image (generally referenced as 104), representing before and after adjusting conditions for comfort push stroller system 100. The left side image 102 is representative of the prior art as discussed above, shown to be uncomfortable to user-pusher 150. FIG. 2, shows a perspective view illustrating ‘in-use’ condition 120 of the comfort push stroller system 100 as used comfortably by a taller (above-average height) user-pusher 150. Both FIGS. 1B and 2 represent comfort push stroller system 100 according to an embodiment of the present invention of FIG. 1B (FIG. 1A does not). Vertically adjustable handle 140 may be produced OEM on comfort push stroller 130 or alternately retro-fit to existing strollers (such as the stroller shown in FIG. 1A).

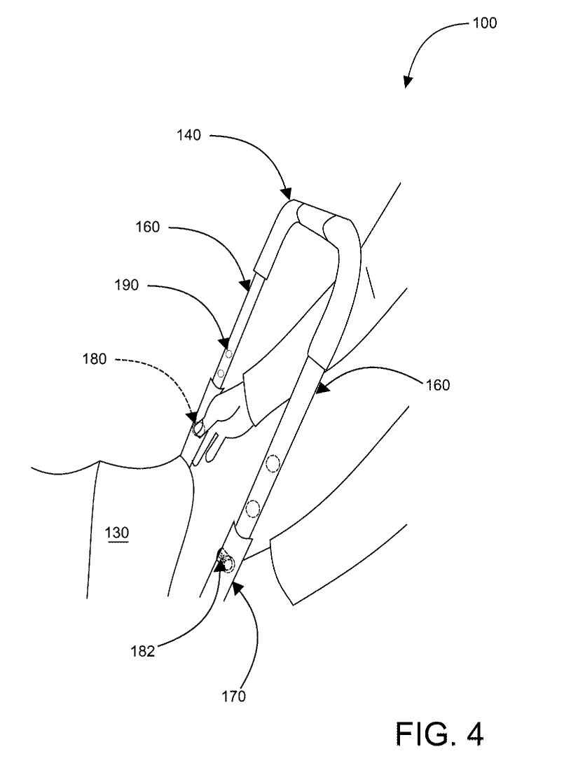

Comfort push stroller system 100 comprises comfort push stroller 130 according to the embodiment shown in the present figures referenced. Comfort push stroller 130 preferably comprises: at least one vertically adjustable handle 140 (may be a one-piece handle construction as referenced in FIG. 4) with at least one inner tube 160; at least one outer tube 170; and at least one push-button 180 located on outer tubing 170. Vertically adjustable handle 140 comprises at least one inner tube 160 and at least one outer tube 170; wherein outer tube 170 fits concentrically over inner tube 160, outer tube 170 being slightly larger in diameter than inner tube 160. In this way the relationship between inner tube 160 and outer tube 170 is adjacent and concentric such that inner tube 160 may be telescopically moved in relation with outer tube 170 such that vertically adjustable handle 140 may be retracted or extended (lengthened and/or shortened). The present invention, further comprising push-button 180 is designed to couple inner tube 160 to outer tube 170 in a locked relationship thereby permitting user 150 to vertically height-adjust and set vertically adjustable handle 140 to a user-preferred height via telescoping action. It should be appreciated that spring 182 (discussed below) within push-button 180 acts upon an insertable member to insert into through-holes 190 to create a contact-relationship to prevent relative movement.

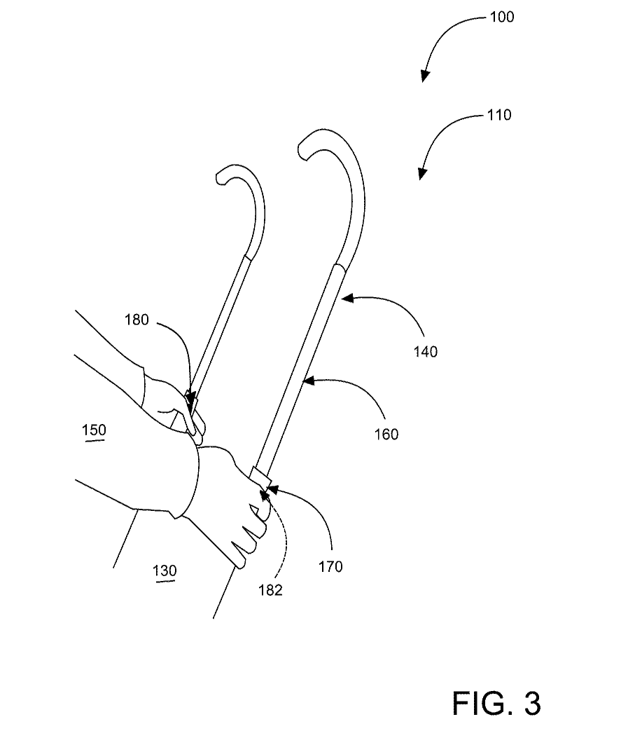

Referring now to FIG. 3 showing a perspective view illustrating user 150 compressing push-buttons 180 to adjust relative handle height of vertically adjustable handle 140 in relation to comfort push stroller 130 according to an embodiment of the present invention of FIG. 1B.

Inner-tube 160, as mentioned above preferably comprises a plurality of through-holes 190. Through-holes 190 comprise apertures and may be located on a mating side-arc portion relative to push-button 180. In certain embodiments push-buttons 180 and through-holes 190 may be located on the inner side of vertically adjustable handle 140 and in other embodiments may be located on the outer side. Push-buttons 180 and through-holes 190 are located on the same side within both of the above-mentioned versions so that they may work in conjunction with one another to provide securing and locking means in a mechanical way via contact friction force.

Push-button 180 within this particular embodiment comprises a mechanical insertion means and may be made out of hard, yet durable material, preferably either plastic, metal or of other such suitable material. The surface of push-button 180 is preferably flat or suitably dome-shaped to accommodate finger of user 150, so as to be easily depressed or pushed to manipulate push-button 180. Push-button 180 is about the size of a quarter within this particular embodiment to substantially prevent accidental finger pinching as user 150 compresses and tensions push-button 180. In other embodiments push-button 180 may comprise other shapes and sizes.

In certain embodiments each push-button 180 comprises a spring 182. Spring 182 is used to store potential mechanical energy and can be wound from pre-hardened stock, or made from annealed steel and hardened after fabrication. Spring 182 is designed to operate alternately between tension and compression states. For example spring 182 is in compression when push-button 180 is compressed/depressed (by user 150), allowing inner-tube 160 to be height adjustable in relation to outer tube 170 (via telescopic sliding motion). Spring 182 is in tension (returns to a natural in-tension state) when push-button 180 is released and inner-tube 160 is in a friction-locked relation to outer tube 170 as push-button 180 is positioned in a locked-inserted position in one of the plurality of through-holes 190. In this way inner-tube 160 is vertically adjustable downwardly and/or upwardly (telescopically), and vertically adjustable handle 140 is height adjusted according to spaced-increments of the plurality of through-holes 190. Once a comfortable user-preferred height (distance from ground to height of hands of user 150) of vertically adjustable handle 140 is achieved (reached), push-button 180 is tensioned thereby locking vertically adjustable handle 140 in a desired location.

Referring now to FIG. 4, a perspective view illustrating user-pusher 150 adjusting vertically-adjustable handle(s) 140 according to an alternate embodiment of the present invention of FIG. 1B.

As shown in the current and previous figures vertically-adjustable handle(s) 140 may comprise one-piece constructions and multiple-piece constructions. In certain embodiments vertically adjustable handle 140 comprises metal (ferrous or non-ferrous metals, alloys or combinations thereof). In other embodiments vertically adjustable handle 140 comprises plastic, composite or other suitable material(s). The materials used are preferably lightweight and durable in service, thus providing relative longevity of the present invention. In this way comfort push stroller system 100 is made cost-effective in use.

Comfort push stroller 130 with vertically adjustable handle 140 may comprise at least one grippable handgrip (may comprise a gripping surface). The handgrip preferably comprises a cushioner to provide a means whereby comfort push stroller 130 is comfortable to push. The cushioner may come in a variety of shapes and graphic themes. Additionally, the cushioner may comprise foam, gel or other flexible soft material such that hands of user 150 are not wearied when pushing comfort push stroller 130. Variously themed cushioners may be removably attachable (via hook and loop fasteners or other suitable means) to vertically adjustable handle 140 and may comprise indicia with cartoon characters, various boy, girl, baby themes. In this way the present invention is user-customizable.

Comfort push stroller system 100 may be sold as kit 106 comprising at least the following parts: comfort push stroller 130 with at least one vertically adjustable handle 140; replacement push-button(s) 180; removable and/or replaceable variously themed cushioners and a set of user instructions. Comfort push stroller system 100 may be manufactured and provided for sale in a wide variety of sizes and shapes for a wide assortment of applications. Upon reading this specification, it should be appreciated that, under appropriate circumstances, considering such issues as design preference, user preferences, marketing preferences, cost, structural requirements, available materials, technological advances, etc., other kit contents or arrangements such as, for example, including more or less components, customized parts, different color combinations, parts may be sold separately, etc., may be sufficient.

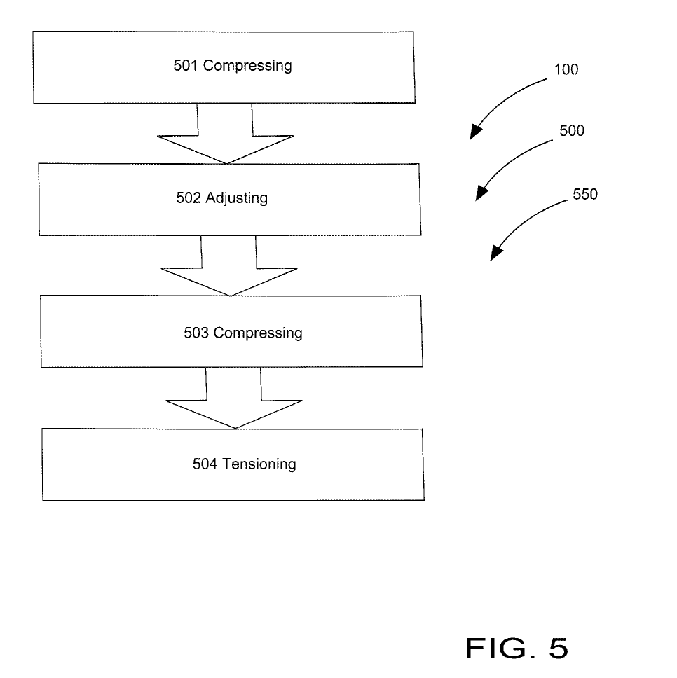

FIG. 5. shows a flowchart 550 illustrating a method of use 500 according to an embodiment of the present invention of FIGS. 1B-4, referring now to FIG. 5. showing a method (at least herein embodying method of use 500) of using comfort push stroller 102 preferably comprises the steps of: step one 501 compressing at least one push-button; step two 502 vertically adjusting (telescoping—shortening or lengthening) inner-tube 160 relative to outer-tube 170 on vertically adjustable handle 140 according to the height of user 150; step three 503 compressing spring 182 inside at least one push-button 180 to release locking relationship between inner tube 160 and outer tube 170; and step four 504 tensioning spring 182 inside at least one push-button 180 once a desired height is reached on the vertically adjustable handle 140 thereby locking inner-tube 160 to the outer-tube 170 such that the comfort push stroller 130 is at a user-preferred height, and vertically adjustable handle 140 is held in rigid stasis for pushing episodes.

It should be noted that the steps described in the method of use can be carried out in many different orders according to user preference. Upon reading this specification, it should be appreciated that, under appropriate circumstances, considering such issues as design preference, user preferences, marketing preferences, cost, structural requirements, available materials, technological advances, etc., other methods of use arrangements such as, for example, different orders within above-mentioned list, elimination or addition of certain steps, including or excluding certain maintenance steps, etc., may be sufficient.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. A comfort push stroller comprising:
at least one vertically adjustable handle;
at least one inner tube;
at least one outer tube; and
at least one push-button located on said outer tubing;
wherein said vertically adjustable handle comprises said at least one inner tube and said at least one outer tube;
wherein said outer tube fits concentrically over said inner tube;
wherein said at least one push-button is designed to couple said inner tube to said outer tube in a tension-locked relationship thereby permitting a user-pusher to vertically height-adjust and set said vertically adjustable handle to a user-preferred height via telescoping action to provide comfort for said user-pusher when pushing said comfort push stroller.

2. The comfort push stroller of claim 1 wherein said inner-tube comprises a plurality of through-holes located on a mating side-arc portion relative to said push-button location on said outer tube.

3. The comfort push stroller of claim 1 wherein said at least one push-button comprises a spring.

4. The comfort push stroller of claim 3 wherein said spring is in compression when said at least one push-button is compressed, allowing said inner-tube to be height adjustable.

5. The comfort push stroller of claim 3 wherein said spring is in tension when said inner-tube is in a friction-locked position, said push-button acting upon an insertable member creating at least one inserted-contact into one of said plurality of through-holes.

6. The comfort push stroller of claim 5 wherein when said inner-tube is vertically adjustable downwardly and/or upwardly, and said vertically adjustable handle is height adjustable according to spaced-increments of said plurality of holes.

7. The comfort push stroller of claim 6 wherein when said user-preferred height of said vertically adjustable handle is achieved, when said at least one push-button is tensioned thereby locking said vertically adjustable handle in a desired position.

8. The comfort push stroller claim 1 wherein said at least one vertically adjustable handle comprises metal.

9. The comfort push stroller of claim 1 wherein said at least one vertically adjustable handle comprises plastic.

10. The comfort push stroller of claim 1 wherein said push-button is the size of a quarter to prevent accidental finger pinching as a user-pusher compresses and tensions said at least one push-button.

11. The comfort push stroller of claim 1 wherein said at least one vertically adjustable handle comprises at least one grippable handgrip.

12. The comfort push stroller of claim 11 wherein said handgrip comprises a cushioner.

13. The comfort push stroller of claim 12 wherein said cushioner comprises foam.

14. The comfort push stroller of claim 12 wherein said cushioner comprises gel.

15. The comfort push stroller of claim 12 wherein said cushioner is removably attachable.

16. A comfort push stroller system comprising:
a comfort push stroller;
at least one vertically adjustable handle comprising metal and at least one removably replaceable cushioner;
at least one inner tube having a plurality of through-holes located on a mating side-arc portion relative to a push-button.
at least one outer tube; and
at least one quarter sized said push-button to prevent accidental finger pinching as a user-pusher compresses and tensions said at least one push-button located on said outer tubing thereby compressing a normally-in-tension spring;
wherein said vertically adjustable handle may be retro-fit to existing strollers and comprises said at least one inner tube and said at least one outer tube;
wherein said at least one outer tube fits concentrically over and around said inner tube;
wherein said at least one push-button is designed to couple said inner tube to said outer tube in a locked relationship thereby permitting a user to vertically height-adjust and lock-set said vertically adjustable handle to a user-preferred height via telescoping action;
wherein said spring is in compression when said at least one push-button is compressed, allowing said inner-tube to be height adjustable
wherein said spring is in tension when said inner-tube is in a friction-locked position in one of said plurality of through-holes;
wherein when said inner-tube is vertically adjustable downwardly and/or upwardly, and said vertically adjustable handle is height adjusted according to spaced-increments of said plurality of holes; and
wherein when said user-preferred height of said vertically adjustable handle is achieved, when said at least one push-button is tensioned thereby locking said vertically adjustable handle in a desired location such that said comfort push stroller may be pushed comfortably by said user-pusher.

17. The comfort push stroller system of claim 16 further comprising a kit including: said comfort push stroller with said at least one vertically adjustable handle; at least one push-button; removable and/or replaceable variously themed said cushioners; and a set of user instructions.

18. A method of use for a comfort push stroller system comprising the steps of:
compressing at least one push-button;
vertically adjusting an inner-tube relative to an outer-tube on a vertically adjustable handle via compressing a spring inside said at least one push-button to release a locking relationship between said inner-tube and said outer-tube;
tensioning said spring inside said at least one push-button once a desired relationship between said inner-tube and said outer-tube is reached on said vertically adjustable handle thereby locking said inner-tube to said outer-tube such that said vertically adjustable handle is held in rigid stasis for pushing episodes at a height comfortable to a user-pusher.
